(19) United States
(12) Patent Application Publication
(10) Pub. No.: US 2012/0168267 A1
(43) Pub. Date: Jul. 5, 2012

(54) CARBON-CERAMIC BRAKE DISC ASSEMBLY

(75) Inventors: Junsang Lee, Seoul (KR); Dongwon Im, Gimhae (KR); Yeonho Choi, Tongyeong (KR); Jungsuk Kang, Jeonju (KR); Byunggun Chea, Jeonju (KR)

(73) Assignee: DACC CO., LTD., Changwon (KR)

(21) Appl. No.: 13/393,413

(22) PCT Filed: Dec. 10, 2009
(86) PCT No.: PCT/KR09/07392

§ 371 Date: Feb. 29, 2012

(30) Foreign Application Priority Data
Sep. 2, 2009 (KR) 10-2009-0082406

(51) Int. Cl. F16D 65/12

(52) U.S. Cl. 188/218 XL

(57) ABSTRACT

There is provided a carbon-ceramic brake disc assembly (200) including a carbon-ceramic brake disc (210) having a first axis hole (211) in the center thereof, and a plurality of first holes (212) around the first axis hole (211), a hat part (220) having a second axis hole (221) in the center thereof, and a plurality of second holes (222) around the second axis hole (221); and a connection unit (230) connecting the carbon-ceramic brake disc (210) and the hat part (220), including bushings (231), each of which includes a head (231a), a body (231b) connecting to the head, and serrations (231c) protruding the outer surface of the body (231b) along the length of the body (231b), with a threaded hole (231d) pierced through the head (231a) and body (231b), lengthwise, the body (231b) being inserted into the first hole (212) in the carbon-ceramic brake disc (210), and the serrations (231c) being penetrated into the internal surface of the second hole (222) in the hat part (220) when forced to be inserted into the second hole (222) in the hat part (220), and a bolt (232) being inserted into the threaded hole (231d) in the head (231a) and body (231b) of the bushing (231). According to the present invention, both configurations of the hat part (220) and the bushing (231) are made simple at low cost. And penetration of the serrations (231c) of the bushing (231) into the hole (222) in the hat part (220) permits a firm connection between the hat part (220) and the carbon-ceramic disc (210).

### TECHNICAL FIELD

The present invention relates to a carbon-ceramic brake disc assembly.

### BACKGROUND ART

A brake for an automotive falls into two categories: a drum brake and a disc brake. The disc brake includes a disc and pads.

The disc brake decelerates or stops a moving automotive by forcing the pads against the rotating disc. Braking action converts kinetic energy into heat. This requires the disc and pad to be made of a material which is lightweight, heat-resistant, erosion-resistant, wear-resistant, and high in strength and to have high coefficients of friction. In this respect, silicon-infiltrated, carbon fiber-reinforced carbon is a material suitable for manufacturing the disc and pad.

FIG. 1 is a perspective, exploded view of a conventional carbon-ceramic brake disc assembly. FIG. 2 is a perspective view of a bushing of FIG. 1.

As shown in FIG. 1, a conventional carbon-ceramic brake disc assembly 100 includes a carbon-ceramic brake disc 110, a hat part 120, and a connection unit 130.

The carbon-ceramic brake disc 110 is made of silicon-infiltrated, carbon fiber-reinforced carbon. The carbon-ceramic brake disc 110 has a first axis hole 111 in the center thereof, and a plurality of holes 112 around the first axis hole 111. The plurality of holes 112 are pierced to be spaced a given distance P1 relative to each other, in a circular line concentric with the center of the carbon-ceramic brake disc 110.

The carbon-ceramic brake disc 110 has cool channels 113 inside. Each of the cool channels 113 is pierced through a core body of the carbon-ceramic brake disc 110 in the radial direction, from the first axis hole 111 to the outer circumferential edge thereof (or vice versa). Outside air, introduced into the cool channels, cools down the carbon-ceramic brake disc 110 while in use.

The hat part 120 is made from a metal, such as a stainless steel. The hat part 120 has a second axis hole 121 in the center thereof. The hat part 120 has a plurality of recesses 122 along the circumferential edge thereof. The plurality of recesses 122 are spaced a given distance P2 relative to each other. Each of the recesses 122, when viewed from above, has a U-shaped across section. That is, each of the recesses 122 is shaped like one formed by cutting away a horseshoe-shaped portion from the circumferential edge of a cylinder. The bottom of each of the recesses 122 is convex in the radial direction of the hat part 120. The plurality of the holes 112 in the carbon-ceramic brake disc 110 aligns with the plurality of the recesses 122.

The connection unit 130 connects the carbon-ceramic brake disc 110 and the hat part 120. The connection unit 130 includes a bushing 131 and a bolt 132.

As shown in FIG. 2, the bushing 131 includes a cap 131A, a head 131B, and a body 131C.

The head 131B has, when viewed from above, has such a cross section which is shaped by cutting a circle along a secant line intersecting a circle in two points. The head 131B has a D-shaped cross section. That is, the head 131B has the upper, bottom, and lateral faces which are plane, and the front and back faces, one of which is convex. The head 131B with this configuration fits into the recess 122 with a uniform clearance that approaches zero.

When the bushing 131B is inserted into the recess 122 in the upright position, the head 131B fits into it, thereby remaining held firmly in place without turning. This is done because the head 131B has the same lateral faces as the recess 122

The bushing 131 has a threaded hole 131D inside, lengthwise. That is, the threaded hole 131D is pierced through the head 131A, the head 131B, and the body 131C.

The bolt 132 is inserted into the threaded hole 131D.

The carbon-ceramic brake 110 and the hat part 120 are connected to each other, in the following manner.

The hat part 120 is mounted on the carbon-ceramic brake disc 110. The holes 112 in the carbon-ceramic brake disc 110 align with the recesses 122 in the hat part 120.

The head 131B of the bushing 131 fits into the recess 122 in the hat part 120 and the body 131C of the bushing 131 is inserted into the hole 112 in the carbon-ceramic brake disc 110.

Above-mentioned configurations of the hat part 120 and the bushing 131 serve to prevent the bushing 131 from turning when the bushing 131 is installed to connect the carbon-ceramic brake disc 110 and the hat part 120. However, manufacturing of the hat part 120 and the bushing 131 requires many mechanical machining processes (including shaping, drilling, turning, milling, and abrasive machining). The major limitation of such a mechanical machining process, which has to be performed on a given material such as a stainless steel, is a strict requirement for geometrical shape and dimensional precision. This makes it difficult to accomplish greater accuracy and precision but at no increase in cost.

### DISCLOSURE OF INVENTION

### Technical Problem

An objective of the present invention is to make simple both configurations of a hat part and a connection unit connecting the hat part and a carbon-ceramic brake disc at low cost, thereby permitting a firm connection between the hat part and the carbon-ceramic brake disc.

### Solution to Problem

According to an aspect of the present invention, there is provided a carbon-ceramic brake disc assembly including, a carbon-ceramic brake disc having a first axis hole in the center thereof, and a plurality of first holes around the first axis hole, a hat part having a second axis hole in the center thereof, and a plurality of second holes around the second axis hole, and a connection unit connecting the carbon-ceramic brake disc and the hat part, including bushings, each of which includes a head, a body connecting to the head, and serrations protruding the outer surface of the body along the length of the body, with a threaded hole pierced through the head and body, lengthwise, the body being inserted into the first hole in the carbon-ceramic brake disc, and the serrations being penetrated into the internal surface of the second hole in the hat part when forced to be inserted into the second hole in the hat part, and a bolt being inserted into the threaded hole in the head and body of the bushing.

The foregoing and other objects, features, aspects and advantages of the present invention will become more apparent from the following detailed description of the present invention when taken in conjunction with the accompanying drawings.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective, exploded view of a conventional carbon-ceramic brake disc assembly

FIG. 2 is a perspective view of a bushing of FIG. 1

FIG. 3 is a perspective, exploded view of an embodiment of a carbon-ceramic brake disc assembly according to the present invention

FIG. 4 is a perspective view of a bushing as shown in FIG. 3 and

FIG. 5 is a cross-sectional view illustrating that serrations of the bushing, as shown in FIG. 3, are penetrated into the internal surface of a second hole in a hat pat.

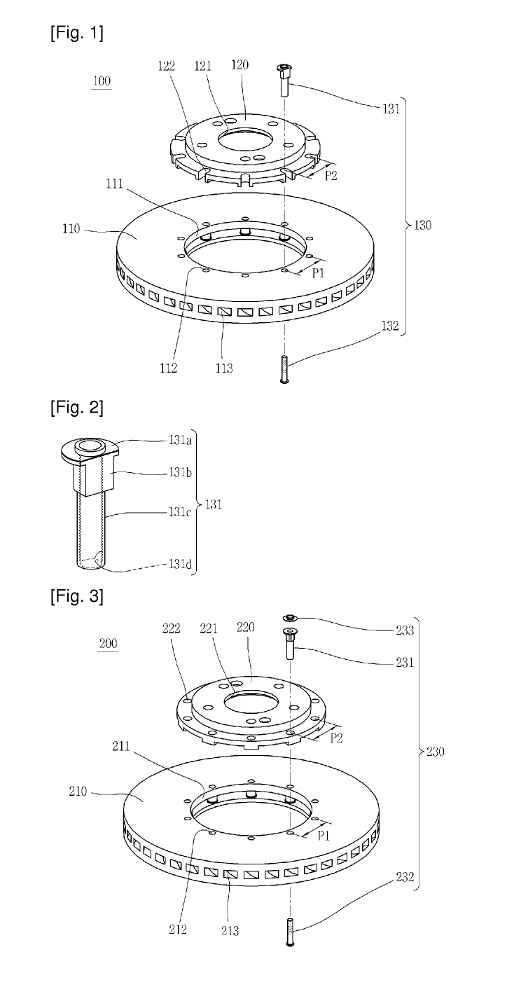

### MODE FOR THE INVENTION

Referring to the accompanying drawings, an embodiment of a carbon-ceramic brake disc assembly according to the present invention is now described.

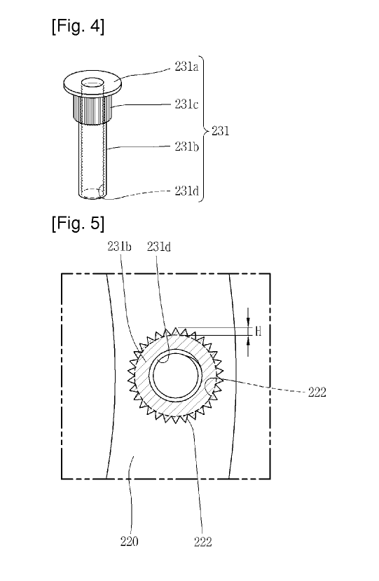

FIG. 3 is a perspective, exploded view of an embodiment of a carbon-ceramic brake disc assembly according to the present invention. FIG. 4 is a perspective view of a bushing as shown in FIG. 3. FIG. 5 is a cross-sectional view illustrating that serrations of the bushing, as shown in FIG. 3, are penetrated into the internal surface of a second hole in a hat pat.

As shown in FIG. 3, the carbon-ceramic brake disc assembly 200 includes a carbon-ceramic brake disc 210, a hat part 220, and a connection unit 230.

The carbon-ceramic brake disc 210 is made of silicon-infiltrated, carbon fiber-reinforced carbon.

The carbon-ceramic brake disc 210 has a first axis hole 211 in the center thereof, and has a plurality of first holes 212 around the first axis hole 211. The plurality of the first holes 212 are located in a circular line concentric with the center of the carbon-ceramic brake disc 210 and are spaced a constant distance P1 relative to each other.

The carbon-ceramic brake disc 210 has cooling channels 213 inside. Each of the cooling channels 213 is pierced through a core body of the carbon-ceramic brake disc 210, in the radial direction, from the first axis hole 211 to the outer circumferential edge thereof (or vice versa). Outside air, introduced through the cooling channels 213, cools down the carbon-ceramic brake disc 210 while in use.

The hat part 220 may be made of a metal such as a stainless steel with the SAE grade 304. The hat part 220 has a second axis hole 221 in the center thereof, and has a plurality of the second holes 222 around the second axis hole 221. The plurality of the second holes 222 are located in a circular line concentric with the center of the hat part 220 and are spaced a constant distance P2 relative to each other.

The circular line concentric with the center of the carbon-ceramic brake disc is the same as the circular line concentric with the center of the hat part, and the distance P1 equals to the distance P2. Thus, the plurality of the second holes 222 in the hat part 220 aligns with the plurality of the first holes 212 in the carbon-ceramic brake disc 210.

The connection unit 230 connects the carbon-ceramic brake disc 210 and the hat part 220. The connection unit 230 includes a bushing 231, a bolt 232, and a nut 233.

As shown in FIG. 4, the bushing 231 includes a head 231A, a body 231B, and serrations 231C.

The head 231A connects to the body 231B. The head 231A and The body 231B may be made from a single piece of material. The bushing 231 has a threaded hole 231D inside. That is, the threaded hole 231D is lengthwise pierced through the head 231A and body 231B making up the bushing 231.

The bushing 231 is made of a metal that is higher in hardness than a metal which the hat part 220 is made of. The bushing 231 may be made of a stainless steel with the SAE 410, which is higher in hardness than a stainless steel with the SAE grade 304.

The body 231B of the bushing 231 has the same diameter as the second hole 222 in the hat part 220, but has a smaller diameter than the first hole 212 in the carbon-ceramic brake disc 210. As a result, the body 231B of the bushing 231 is readily inserted into and withdrawn from the first hole 212 in the carbon-ceramic brake disc 210. But, once it is inserted into the second hole 222 in the hat part 220, the body 231B of the bushing 231 is difficult to be withdrawn from the second hole 222. This is because the serrations 231C are penetrated into the inner surface of the second hole 222 in the hat part 220.

The serrations 231C protrude from the outer surface of the body 231B, along the length of the body 231B of the bushing 231. The serrations 231C are shaped by machining a plain outer surface of the material for the body 231B lengthwise. Each of the serrations 231C is 0.1˜0.2 mm in height. The number of the serrations 231C may range from 20 to 30, which is suitable for preventing the body 231B of the bushing 231 from turning, when the body 231B of the bushing 231 is inserted into the second hole 222 in the hat part 220.

A procedure is now described for assembling the carbon-ceramic brake disc 210 and the hat part 220 with the connection unit 230.

As shown in FIGS. 3 and 4, the bushing 231 is forced to be inserted into the second hole 222 in the hat part 220. At this point, the serrations 231C of the bushing 231 are penetrated into the inner surface of the second hole 222 in the hat part 220, as shown in FIG. 5. This is readily done because the bushing 231 is made of a stainless steel with the SAE 410, which is higher in hardness than a stainless steel with the SAE grade 304 which the hat part 220 is made of, and the height of each of the serrations 231C is within a relatively small range of 0.1 to 0.2 mm. As a result, the bushing 231 is prevented from turning.

Next, the bushing 231 is mounted to the carbon-ceramic brake disc 210, to align the second hole 222 with the first hole 212, and then the body 231B of the bushing 231 is inserted into the first hole 212 in the carbon-ceramic brake disc 210.

The bolt 232 is inserted into the threaded hole 231D in the bushing 231, and the nut 233 is screwed onto the end portion of the bolt 232, which protrudes from the threaded hole 231D, thereby completing connection between the carbon-ceramic brake disc 210 and the hat part 220.

The carbon-ceramic brake disc assembly according to the present inventions has the following advantages.

Both configurations of the hat part and the bushing are made simple at low cost. Penetration of the serrations of the bushing into the hole in the hat part permits a firm connection between the hat part and the carbon-ceramic disc.

The bushing with the serrations weighs 40 percent less than the conventional bushing with the shaped head.

Screwing of the nut onto the bolt provides an additional firm connection between the hat part and the carbon-ceramic brake disc.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A carbon-ceramic brake disc assembly comprising:
a carbon-ceramic brake disc having a first axis hole in the center thereof, and a plurality of first holes around the first axis hole;
a hat part having a second axis hole in the center thereof, and a plurality of second holes around the second axis hole; and
a connection unit connecting the carbon-ceramic brake disc and the hat part, comprising:
bushings, each of which includes a head, a body connecting to the head, and serrations protruding the outer surface of the body along the length of the body, with a threaded hole pierced through the head and body, lengthwise, the body being inserted into the first hole in the carbon-ceramic brake disc, and the serrations being penetrated into the internal surface of the second hole in the hat part when forced to be inserted into the second hole in the hat part; and
a bolt being inserted into the threaded hole in the head and body of the bushing.

2. The carbon-ceramic brake disc assembly according to claim 1, wherein the carbon-ceramic brake disc has the plurality of the first holes which are located in a circular line concentric with the center thereof, and are spaced a constant distance relative to each other, and the hat part has the plurality of the second holes which are located in a circular line concentric with the center thereof and are spaced the constant distance relative to each other, with the circular line concentric with the center of the carbon-ceramic brake disc being the same as the circular line concentric with the center of the hat part.

3. The carbon-ceramic brake disc assembly according to claim 1, wherein the bushing is made of a material which is higher in hardness than a material which the hat part is made of.

4. The carbon-ceramic brake disc assembly according to claim 3, wherein the bushing is made of a stainless steel with the SAE grade 410 and the hat part is made of a stainless steel with SAE grade 304.

5. The carbon-ceramic brake disc assembly according to claim 1, wherein the body of the bushing has the same diameter as the second hole in the hat part, but has a smaller diameter than the first hole in the carbon-ceramic brake disc.

6. The carbon-ceramic brake disc assembly according to claim 1, wherein the height of each of the serrations is within a relatively small range of 0.1 to 0.2 mm.

7. The carbon-ceramic brake disc assembly according to claim 1, wherein the connection unit further comprises a nut which is screwed on to the end portion of the bolt, which protrudes from the threaded hole.

8. The carbon-ceramic brake disc assembly according to claim 2, wherein the connection unit further comprises a nut which is screwed on to the end portion of the bolt, which protrudes from the threaded hole.

9. The carbon-ceramic brake disc assembly according to claim 3, wherein the connection unit further comprises a nut which is screwed on to the end portion of the bolt, which protrudes from the threaded hole.

10. The carbon-ceramic brake disc assembly according to claim 4, wherein the connection unit further comprises a nut which is screwed on to the end portion of the bolt, which protrudes from the threaded hole.

11. The carbon-ceramic brake disc assembly according to claim 5, wherein the connection unit further comprises a nut which is screwed on to the end portion of the bolt, which protrudes from the threaded hole.

12. The carbon-ceramic brake disc assembly according to claim 6, wherein the connection unit further comprises a nut which is screwed on to the end portion of the bolt, which protrudes from the threaded hole.
